(19) United States
(12) Patent Application Publication
(10) Pub. No.: US 2021/0253978 A1
(43) Pub. Date: Aug. 19, 2021

(54) PERFUME/SILICONE EMULSIONS AND RELATED CONSUMER PRODUCTS

(71) Applicant: The Procter & Gamble Company, Cincinnati, OH (US)

(72) Inventors: Rajan Keshav PANANDIKER, West Chester, OH (US); Chathurika R. K. JAYASUNDARA, Cincinnati, OH (US); Bernard William KLUESENER, Harrison, OH (US); Carola BARRERA, West Chester, OH (US)

(21) Appl. No.: 17/168,479

(22) Filed: Feb. 5, 2021

(30) Foreign Application Priority Data
Feb. 7, 2020 (EP) 20156010.9

(51) Int. Cl. C11D 3/37; C11D 3/50; C11D 3/30; C11D 3/00; C11D 11/00; C11D 17/00

(52) U.S. Cl. CPC C11D 3/3742; C11D 3/50; C11D 17/0017; C11D 3/0015; C11D 11/0017; C11D 3/30

(57) ABSTRACT

Silicone/perfume emulsion compositions that include an aminofunctional silicone, one or more emulsifiers, one or more perfume raw materials, and water. Consumer products that include such emulsion compositions. Related methods of making and using such emulsions and consumer products.

### FIELD OF THE INVENTION

The present disclosure relates to silicone/perfume emulsion compositions that include an aminofunctional silicone, one or more emulsifiers, one or more perfume raw materials, and water. The present disclosure also relates to consumer products that include such emulsion compositions. The present disclosure further relates to methods of making and using such compositions.

### BACKGROUND OF THE INVENTION

Manufacturers of certain consumer products may wish to include silicone in their products to provide, for example, conditioning benefits. Silicones may be added as emulsions to facilitate easy incorporation into the final product, product stability, and/or consistent product performance. When such silicones are aminofunctional silicones, the emulsions are typically at a low pH (e.g., less than 4), as the acidic environment facilitates protonation of the amine groups and tend to improve emulsion stability. However, formulating the low-pH emulsions can include additional processing steps and otherwise unnecessary ingredients (such as pH adjustors) that provide little benefit in the final product.

Perfumes may also be added to consumer products as emulsions. However, due to the volatile and often hydrophobic nature of perfume oils, the manufacturer faces a constant struggle to improve perfume performance, for example by improving deposition efficiency.

There is a need for improved perfume/silicone emulsion compositions, as well as consumer products that incorporate such emulsions, that also offer good performance.

### SUMMARY OF THE INVENTION

The present disclosure relates to perfume/silicone emulsion compositions and consumer products that include such emulsions.

For example, the present disclosure relates to a perfume/silicone emulsion composition (“emulsion composition”) that includes: an aminofunctional silicone, where the aminofunctional silicone includes one or more primary amine moieties, and where the aminofunctional silicone is characterized by a total amine content of from about 0.05 to about 2.2; one or more emulsifiers; one or more perfume raw materials, where the one or more perfume raw materials includes an aldehyde moiety, a ketone moiety, or combinations thereof; and water.

The present disclosure also relates to a method of making the perfume/silicone emulsion composition disclosed herein, where the method includes the step of mixing the aminofunctional silicone, the one or more emulsifiers, and the one or more perfume raw materials in the presence of the water.

The present disclosure also relates to a consumer product composition that includes the perfume/silicone emulsion composition disclosed herein, and a consumer product adjunct. The present disclosure also relates to a method of making such consumer products, where the method includes the step of combining the emulsion with the consumer product adjunct.

The present disclosure also relates to a method of treating a surface, preferably where the surface is a fabric, the method including the step of contacting the surface with the consumer product composition disclosed herein, optionally in the presence of water.

### DETAILED DESCRIPTION OF THE INVENTION

The present disclosure relates to perfume/silicone emulsion compositions, methods of making such emulsions, consumer products that incorporate such emulsions, and methods of making and using such consumer products.

More specifically, it has been found that well-performing emulsions (and consumer products incorporating such emulsions) can be made in an effective manner when careful selections are made with regard, for example, to one or more of the following components of the emulsion: the starting aminofunctional silicone (e.g., relatively water-insoluble); the perfume raw materials (e.g., the desired functional groups and/or reactivity); the emulsion pH (e.g., higher than is typical); and/or the emulsifying surfactant (e.g., some work better than others, and a combination may work even better).

Without wishing to be bound by theory, it is believed that in the emulsion, the aminofunctional silicone provides small hydrophobic domains (or “microenvironments”) into which the selected perfume raw materials, many of which are hydrophobic, can migrate or partition. With the perfume thus tightly associated with the silicone, the emulsions can be conveniently added to a base composition to make consumer product compositions. It is even believed that the association is maintained in the final product, and can result in improved perfume deposition and release upon product usage.

The perfume/silicone emulsion compositions, related consumer products, and related methods of making and usage are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein, “amine content,” “amine value,” and “amine content values” are used interchangeably unless indicated otherwise and can be determined according to the method provided in the Test Method section. Weight percent of nitrogen can be determined from the total amine value as provided in the Test Method Section.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Perfume/Silicone Emulsion Composition

The present disclosure relates to perfume/silicone emulsion compositions. As used herein, “perfume/silicone emulsion composition,” “perfume/silicone emulsion,” “silicone emulsion,” and even simply “emulsion” are used interchangeably, unless indicated otherwise.

The perfume/silicone emulsion compositions of the present disclosure may be useful for providing improved freshness and/or conditioning capabilities to the consumer product compositions.

The perfume/silicone emulsions of the present disclosure may comprise an aminofunctional silicone, one or more emulsifiers, one or more perfume raw materials, and water.

The emulsion may comprise from about 30% to about 90%, or from about 35% to about 75%, or from about 35% to about 50%, by weight of the emulsion, of water.

The emulsion may be characterized by a pH of 7.0 or greater, preferably a pH of from 7.0 to about 12, more preferably from about 8 to 11, even more preferably from about 9 to about 11, or about 10. The pH of the silicone emulsion is determined at a 10% dilution (by weight) in deionized water (e.g., 10 parts by weight of the emulsion, 90 parts by weight of the water) at about 20° C., using a suitable meter calibrated according to the manufacturer's instructions. In general, it is known that the stability of silicone emulsions is increased significantly in an acidic pH environment compared to a neutral or basic environment. This is because the amine groups of the aminofunctional silicone tend to become protonated in the acidic environment, which is believed to provide charge-stabilization to the silicone emulsion. As such it is often difficult to produce silicones of particle size from 0.5 to 5 microns in an emulsion having a basic pH. However, the emulsions according to the present disclosure are surprisingly stable at non-acidic pHs, believed to be due to the particular selection of aminofunctional silicones, PMRs, emulsifiers, and/or processing steps.

The emulsion may be characterized by a viscosity, for example from about 10 to about 500 Pa·s, preferably from about 20 to about 400 Pa·s, more preferably from about 25 to about 300 Pa·s, even more preferably from about 100 to about 300 Pa·s, measured at 0.1 rad/s and 25° C. Obtaining an emulsion with the target viscosity may be desirable for processability reasons, particularly as emulsions having a very high viscosity may be difficult to formulate. Furthermore, it has surprisingly been found that certain combinations of aminofunctional silicones and perfume raw materials can lead to mixtures that gel and are thus unsuitable for formulation into a consumer product composition.

The perfume/silicone emulsion may comprise a plurality of droplets. The plurality of droplets may be characterized by a mean diameter of from about 1 micron to about 5 microns. Without wishing to be bound by theory, it is believed that droplets of a certain minimum size are desired for efficiency of deposition onto the target surface, but that droplets that exceed a certain size can create performance and/or stability issues, such spotting on the target surface.

The emulsion may be obtained, or may be obtainable, by mixing an aminofunctional silicone, an emulsifier, and one or more perfume raw materials in the presence of water.

The perfume/silicone emulsion may be made in a series of steps; in particular, water may be added to the silicone in a series of steps. For example, the silicone may be provided; one or more emulsifiers may be combined with the silicone; a first portion of water may be added and the mixture is agitated, for example for 15 minutes; a second portion of water may be added and the mixture is agitated, for example for 15 minutes; a third portion of water may be added and the mixture is agitated, for example for 15 minutes; then the perfume may be added. It has been observed that adding the entire portion of water in a single step results in poorly dispersible mixtures/emulsions, such as those where the silicone remains in the continuous phase.

As described above, the emulsion may be obtained from an aminofunctional silicone, an emulsifier, and one or more perfume raw materials. Each of these materials is discussed in more detail below.

1. Aminofunctional Silicone

The silicone emulsion may be prepared with an aminofunctional silicone. The aminofunctional silicone may comprise one or more primary amine moieties. Without wishing to be bound by theory, it is believed that the one or more primary amine moieties may interact with the one or more perfume raw materials as described below to provide an effective perfume delivery system upon intended end use. Preferably, the aminofunctional silicone has more than one primary amine moieties, as it is believed that relatively more primary amine moieties will result in more effective perfume delivery, particularly with regard to silicone mass efficiency.

The emulsion may comprise from about 10% to about 70%, or from about 25% to about 65%, or from about 50% to about 65%, by weight of the emulsion, of the aminofunctional silicone.

The aminofunctional silicone may be relatively insoluble. For example, the aminofunctional silicone may be characterized by a solubility of less than about 10 mg/L in deionized water at 25° C. Without wishing to be bound by theory, it is believed that selecting a relatively insoluble aminofunctional silicone allows for the perfume raw materials in the silicone emulsion, which tend to be relatively hydrophobic themselves, to partition into the silicone droplets and away from the water of the emulsion, thereby being in association with the aminofunctional silicone and contributing to more effective perfume delivery.

The aminofuncational silicone may be characterized by one or more amine content values. The amine content, namely the primary, secondary, tertiary, and/or total amine values (meq/g), is defined as the milliequivalents of amine functionality (primary, secondary, tertiary, and/or total) present in one gram of a sample. Without wishing to be bound by theory, it is believed that the amine content of the aminofunctional silicone contributes, at least in part, to the solubility in water of the aminofunctional silicone. For example, as amine content increases, the aminofunctional silicone is generally more soluble in water. Therefore, it may be desirable to limit the nitrogen content of the aminofunctional silicone in order to maintain a relatively low solubility, thereby facilitating portioning of the perfume materials out of the aqueous phase of the emulsion.

The aminofunctional silicone may be characterized by a total amine content of from about 0.05 to about 2.2, preferably from about 0.071 to about 2.14, or from about 0.071 to about 1.78, or from about 0.71 to about 1.43, or from about 0.14 to about 1.07, or from about 0.14 to about 0.71, or from about 0.21 to about 0.71, or from about 0.36 to about 0.71. The aminofunctional silicone may be characterized by a primary amine content of from about 0.05 to about 2.2, preferably from about 0.071 to about 2.14, or from about 0.071 to about 1.78, or from about 0.71 to about 1.43, or from about 0.14 to about 1.07, or from about 0.14 to about 0.71, or from about 0.21 to about 0.71, or from about 0.36 to about 0.71. The aminofunctional silicone may characterized by a ratio of primary amine content to total amine content of from about 1:2 (e.g., 50%) to about 2:2 (e.g., 100%), or from about 1.2:2, or from about 1.5:2, or from about 1.8:2. It may be preferred to select an aminofunctional silicone having a relatively high proportion of primary amines compared to total amines to improve the PRM loading efficiency, given that on fabric it is believed that the PRM residues be associated with, or may even have reacted with, primary amines.

The aminofunctional silicone may be characterized by a weight percentage of nitrogen. For example, the aminofunctional silicone may be characterized by a nitrogen content of from about 0.1% to about 3%, or from about 0.1% to about 2%, or from about 0.2% to about 1.5%, or from about 0.2% to about 1.0%, or from about 0.3% to about 0.8%, or from about 0.3% to about 0.75%, reported as functional group equivalent weight %. The functional group equivalent weight percentage can be determined from the amine values of the aminofunctional silicone, as described in more detail in the Test Methods section.

The aminofunctional silicone may be characterized by the following formula:

[R₁R₂R₃SiO_{1/2}]₍ⱼ₊₂ₗ₊₂₎[R₄R₅SiO_{2/2}]ₘ[R₆SiO_{3/2}]ⱼ[SiO_{4/2}]ₗ

wherein:

j is an integer from 0 to 150, preferably from 0 to 50, more preferably from 0 to 20;

m is an integer from 10 to 1500, preferably 10 to 1000, more preferably from 20 to 500;

l is an integer from 0 to 150, preferably from 1 to 150, more preferably from 0 to 50, most preferably from 0 to 20;
with the provisio j+m+l equals an integer greater than or equal to 50;

each of R₁, R₂, R₃, R₄, R₅ and R₆ moieties is independently selected from the group consisting of H, OH, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl, C₁-C₃₂ alkoxy and C₁-C₃₂ substituted alkoxy, and X—Z, wherein at least one of the moieties R₁ through R₆=X—Z,

preferably wherein each R₁₋₆ is independently selected from the group consisting of OH, C₁-C₂ alkyl, C₁-C₂ substituted alkyl, C₁-C₂ alkoxy, C₁-C₂ substituted alkoxy, and X—Z;

wherein each X is independently a substituted or unsubstituted divalent alkylene or alkylidene radical comprising 2-12 carbon atoms, preferably each X is independently a substituted or unsubstituted divalent alkylene or alkylidene radical comprising 2-6 carbon atoms, most preferably each X is independently a substituted or unsubstituted divalent alkylene or alkylidene radical comprising 2-4 carbon atoms;

wherein each Z is a moiety comprising the one or more primary amine moieties, preferably wherein each Z is independently selected from the group

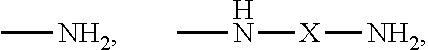

or a mixture thereof.

Z may be —NH₂. Z may be

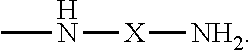

Without wishing to be bound by theory, it is believed that the primary amine and the at least one perfume raw material may react or complex by the time the material deposits onto a target surface, such as a fabric, resulting in superior deposition compared to if only the perfume were contacted with the target surface. As the perfume raw material releases from the aminofunctional silicone, the PRM can then volatilize, resulting in an improved freshness profile and/or a prolonged release.

Commercially available aminofunctional silicones suitable for the emulsions, compositions, and processes of the present disclosure may include: KF-393, KF-861, KF-864, KF-867, KF-869, KF-880, KF-8002, KF-8003, KF-8004, and KF-8005 (all ex Shin-Etsu); SF 1708 fluid (ex Momentiv); and AMS-152, AMS-162, AMS-163, and AMS-233 (all ex Gelest).

2. Emulsifier

The silicone emulsion may be prepared with one or more emulsifiers. Selection of proper emulsifier can facilitate formation of silicone and/or perfume droplets of desired size, and/or the stable incorporation of silicone and/or perfume into a final product. Emulsifiers may also be selected so as to not have an undesirable impact on viscosity of the emulsion, for example by increasing the viscosity to an undesirable level.

The one or more emulsifiers may comprise a nonionic surfactant. Suitable nonionic surfactant may include alkoxylated fatty alcohols. The nonionic surfactant may be selected from ethoxylated alcohols and ethoxylated alkyl phenols of the formula R(OC2H4),OH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15.

Other non-limiting examples of nonionic surfactants useful herein include: C8-C18 alkyl ethoxylates, such as, NEODOL® nonionic surfactants from Shell; C6-C12 alkyl phenol alkoxylates where the alkoxylate units may be ethyleneoxy units, propyleneoxy units, or a mixture thereof; C12-C18 alcohol and C6-C12 alkyl phenol condensates with ethylene oxide/propylene oxide block polymers such as Pluronic® from BASF; C14-C22 mid-chain branched alcohols, BA; C14-C22 mid-chain branched alkyl alkoxylates, BAEX, wherein x is from 1 to 30; alkylpolysaccharides; specifically alkylpolyglycosides; polyhydroxy fatty acid amides; and ether capped poly(oxyalkylated) alcohol surfactants. Specific example include C11-C15 EO12 and C11-C15 EO9 Tergitol® nonionic surfactants from Dow, C12-C15 EO7 and C14-C15 EO7 NEODOL® nonionic surfactants from Shell, C12-C14 EO7 and C12-C14 EO9 Surfonic® nonionic surfactants from Huntsman. Other suitable nonionic surfactants are the condensation products of Guerbet alcohols with from 2 to 18 moles, preferably 2 to 15, more preferably 5-9 of ethylene oxide per mole of alcohol. Suitable nonionic surfactants include those with the trade name Lutensol® from BASF. Lutensol XP-50 is a Guerbet ethoxylate that contains 5 ethoxy groups. Lutensol XP-80 and containing 8 ethoxy groups. Other suitable non-ionic surfactants for use herein include fatty alcohol polyglycol ethers, alkylpolyglucosides and fatty acid glucamides, and/or alkylpolyglucosides based on Guerbet alcohols.

The one or more emulsifiers may comprise linear emulsifiers, branched emulsifiers, or mixtures thereof, preferably linear nonionic surfactants, branched nonionic surfactants, or mixtures thereof. Branched emulsifiers, particularly branched nonionic emulsifiers, may be preferred for emulsifying the aminosilicone, as it is believed that the branching facilitates relatively better packing of the aminosilicone.

The emulsifier may comprise a first emulsifier and a second emulsifier that is different from the first emulsifier. The first emulsifier, which may be used to emulsify the perfume raw materials, may be a linear emulsifier, preferably a linear nonionic surfactant, and/or the second emulsifier, which may be used to emulsify the aminofunctional silicone, may be a branched emulsifier, preferably a branched nonionic surfactant. Suitable linear emulsifiers may include C₁₂-C₁₄ EO9 Surfonic (ex Huntsman). Suitable branched emulsifiers may include Tergitol 15-S-3 (ex Dow), Tergitol 15-S-5 (ex Dow), Tergitol 15-S-9 (ex Dow), Tergitol 15-S-12 (ex Dow), and Lutensol XL70 (ex BASF).

The one or more emulsifiers may be substantially hydrophobic. The one or more emulsifiers may be characterized by an HLB value of from about 5 to about 20, or from about 8 to about 16. The HLB value of a nonionic surfactant may be determined according to the method provided below.

To select an appropriate emulsifier, it may be useful to compare the amount of ethoxylate (“EO”) groups of a proposed ethoxylated nonionic surfactant emulsifier and the nitrogen wt % of the aminofuncational silicone. For example, the ratio of EO groups in the emulsifier (by weight) to the nitrogen content in the aminofunctional silicone (by weight) may be from about 50 to about 600, or from about 75 to about 550. This ratio is a short-hand attempt to roughly correlate and match the relative hydrophobicity of the emulsifier and the aminofunctional silicone. Failing to get an appropriate match can lead to a failure to achieve a suitable oil-in-water emulsion, if any at all.

3. Perfume Raw Materials

The silicone emulsion may be prepared with one or more perfume raw materials, where the one or more perfume raw materials comprise an aldehyde moiety, a ketone moiety, or combinations thereof. As described above, it is believed that PRMs with aldehyde or ketone moieties can interact with the primary amine moieties of the aminofunctional silicones described herein in a way that results in improved perfume performance in a consumer product. Furthermore, it is believed that certain PRM structures are more likely to perform better than others.

In general, the term “perfume raw material” (or “PRM”) as used herein refers to compounds having a molecular weight of at least about 100 g/mol and which are useful in imparting an odor, fragrance, essence, or scent, either alone or with other perfume raw materials. Typical PRMs comprise inter alia alcohols, ketones, aldehydes, esters, ethers, nitrites, and alkenes, such as terpene. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

The PRMs may be characterized by their boiling points (B.P.) measured at the normal pressure (760 mm Hg), and their octanol/water partitioning coefficient (P), which may be described in terms of log P, determined according to the test method below. A perfume having a variety of PRMs characterized by different boiling points and/or log Ps may be desirable, for example, to provide fragrance benefits at different touchpoints during normal usage.

The one or more perfume raw materials may be characterized by the following structure:

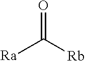

wherein Ra is selected from the group consisting of: C₃-C₁₈ alkyl, C₃-C₁₈ alkenyl, C₃-C₁₈ substituted alkyl,

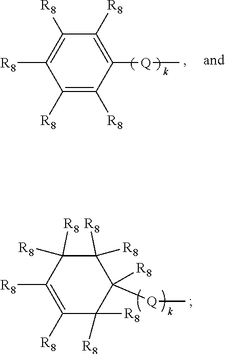

wherein each R₈ is independently selected from the group consisting of H, straight or branched chain C₁-C₈ alkyl, C₁-C₈ substituted alkyl, and C₁-C₂ alkoxy; k is an integer with value 0 or 1; Q is an alkylene radical with from 2 to 8 carbon atoms; and wherein Rb is selected from H and —CH═CH—R₉, wherein R₉ is selected from H or a C₁-C₃ alkyl group. When Rb is H, the structure comprises an aldehyde moiety.

The Ra group may be selected from the group consisting of:

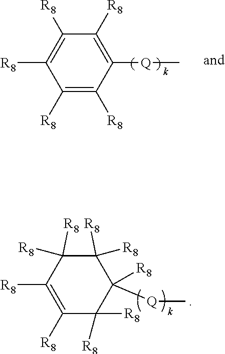

At least two R₈ groups may be fused to form a bicyclic structures, preferably a bicyclic structure selected from the group consisting of:

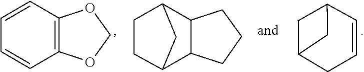

Each Q may be independently selected from

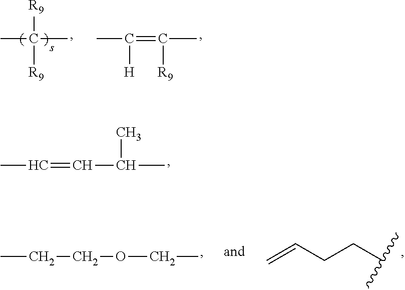

wherein s is an integer from 1 to 4, wherein each R₉ is independently selected from H or C₁-C₃ alkyl group, and where [symbol] (which may also be shown as an asterix, i.e. “*”) represents the end of the moiety linked to the Ra group. Preferably, each Q is independently selected from

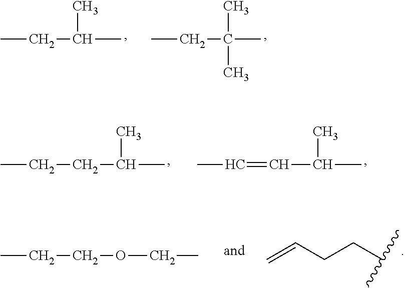

The Rb group may be H; in such cases, the perfume raw material typically comprises an aldehyde moiety.

The Rb group may be —CH═CH—R₉, wherein R₉ is selected from H or a C₁-C₃ alkyl group; in such cases, the perfume raw material typically comprises a ketone moiety.

The one or more perfume raw materials may be characterized by the following structure:

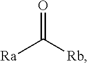

wherein Ra and Rb are selected from one of the following combinations:
a. Ra is selected from the group consisting of: C₃-C₁₈ alkyl, C₃-C₁₈ alkenyl, and C₃-C₁₈ substituted alkyl; and Rb is H;
b. Ra is selected from

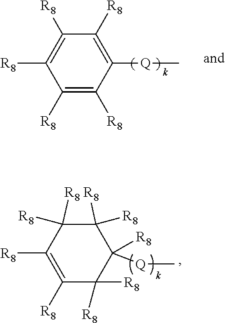

wherein k is 0, wherein R₈ is selected from the group consisting of H, C₁-C₃ alkyl, and C₁-C₂ alkoxy; and Rb is 0;
c. Ra is selected from the group consisting of:

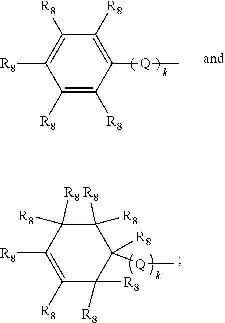

k is 1; R₈ is selected from the group consisting of H, C₁-C₃ alkyl, and C₁-C₂ alkoxy; Q is selected from the group consisting of:

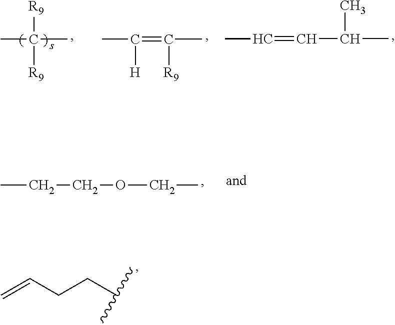

wherein s is an integer from 1 to 4, wherein each R₉ is independently selected from H or C₁-C₃ alkyl group,
preferably wherein Q is selected from

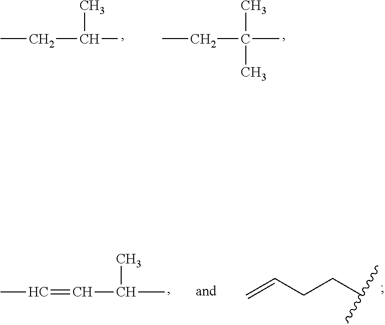

### and Rb is H;

d. Ra is selected from the group consisting of:

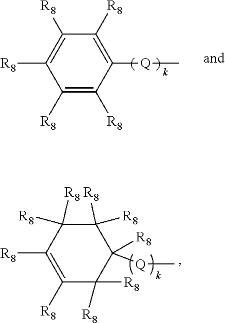

wherein k is 0, and Rb is —CH═CH—R₉, wherein each R₉ is independently selected from H or C₁-C₃ alkyl group; or
e. mixtures thereof.

The one or more perfume raw materials may comprise structures (which may be substituted) selected from the following:

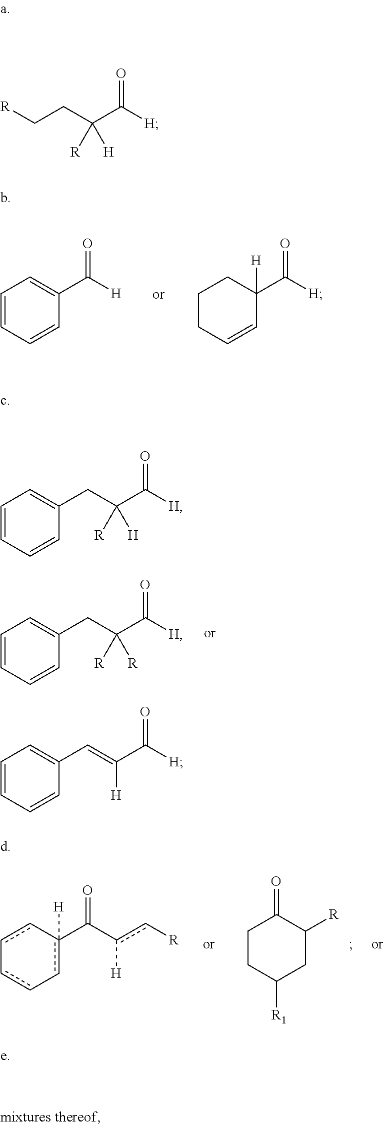

where each R and/or R₁ is independently a suitable substituent moiety of the PRM, for example selected from the group C₃-C₁₈ alkyl, C₃-C₁₈ alkenyl, and C₃-C₁₈ substituted alkyl; or selected from the group H, C₁-C₃ alkyl, and C₁-C₂ alkoxy. To note, the structures of a.-d. are selections of the PRMs described in groups a.-d. above.

The one or more perfume raw materials may be selected from the following:

a. oncidal, methyl nonyl acetaldehyde, adoxal, melanal, calypsone, or mixtures thereof;

b. cuminic aldehyde, benzaldehyde, anisic aldehyde, heliotropin, isocyclocitral, triplal/ligustral, 3,6-ivy carbaldehyde, ligustral, scentenal, or mixtures thereof;

c. satinaldehyde (jasmorange), otropal, cyclamen homoaldehyde, cyclamen aldehyde (cyclamal), lilial, canthoxal, floralozone, cinnemic aldehyde, or mixtures thereof;

d. delta-damascone, beta-damascone, alpha-damascone, nectaryl, or mixtures thereof;

e. vanillin, ethyl vanillin, or mixtures thereof; or

f. a combination of materials selected from at least two of a, b, c, d, and e.

To note, the specifically named perfume raw materials of groups a.-d. are selections of the structures provided in groups a.-d. in each of the previous sections above.

Perfume raw materials having these identities and/or structures (e.g., those described in groups a.-d.) have been found to perform surprisingly well in compositions according to present disclosure, as evidenced by relatively high headspace measurements on treated fabric, compared to other PRM structures. Furthermore, it is believed that vanillin and/or ethyl vanillin (described in e. of the last list above) also perform substantially well in the methods and compositions of the present disclosure, even though such performance may not be substantially indicated by the present headspace analysis method.

### Consumer Product Compositions

The present disclosure also relates to consumer product compositions, as well as methods of making and using such consumer product compositions. The consumer product compositions may be useful for treating a surface, for example to freshen and/or condition the surface, such as fabric, hair, or skin. The consumer product compositions may comprise a perfume/silicone emulsion composition according to the present disclosure and a consumer product adjunct. The consumer product compositions may be made by providing a perfume/silicone emulsion composition according to the present disclosure, and combining the emulsion with a consumer product adjunct. The consumer product adjunct may be part of a base composition.

The consumer product compositions according to the present disclosure may be in the form of a liquid composition, a granular composition, a single-compartment pouch, a multi-compartment pouch, a dissolvable sheet, a pastille or bead, a fibrous article, a tablet, a bar, a flake, a non-woven sheet, or a mixture thereof.

The consumer product compositions of the present disclosure may be a household care composition, preferably a household care composition selected from the group consisting of a fabric and home care product, a beauty care product, or a mixture thereof.

When the consumer product composition is a fabric and home care product, the fabric and home care product may preferably be selected from a laundry detergent composition, a fabric conditioning composition, a fabric pre-treatment composition, a fabric refresher composition, or a mixture thereof. The fabric conditioning composition may preferably be a liquid fabric conditioning composition.

When the consumer product composition is a beauty care product, the beauty care product may preferably be selected from a hair treatment product, a skin care product, a shave care product, a personal cleansing product, a deodorant and/or antiperspirant, or a mixture thereof. The hair treatment product preferably may preferably be a shampoo, a conditioner, or a combination thereof.

The consumer product composition may include a consumer product adjunct, in addition to the silicone emulsion. The consumer product adjunct may be any adjunct ingredient, in any amount, that is suitable for the intended product and/or intended end-use of the product.

The consumer product adjunct may be part of a base composition that is combined with the silicone emulsion. For example, the present disclosure relates to a method of making a consumer product that includes the step of combining a silicone emulsion with a base composition, where the base composition comprises a consumer product adjunct. The silicone emulsion may be added to the base composition. Consumer product adjuncts may be added to the base composition before and/or after the silicone emulsion is added to the base composition.

Consumer product adjuncts may be useful as performance aids, stability or processing aids, or both. For example, the consumer product adjunct may be selected from an amine, a surfactant system, a water-binding agent, a sulfite, fatty acids and/or salts thereof, enzymes, encapsulated benefit agents, soil release polymers, hueing agents, builders, chelating agents, dye transfer inhibiting agents, dispersants, enzyme stabilizers, catalytic materials, bleaching agents, bleach catalysts, bleach activators, polymeric dispersing agents, soil removal/anti-redeposition agents, polymeric dispersing agents, polymeric grease cleaning agents, brighteners, suds suppressors, dyes, hueing agents, free perfume, structure elasticizing agents, conditioning or softening agents, carriers, fillers, hydrotropes, organic solvents, anti-microbial agents and/or preservatives, neutralizers and/or pH adjusting agents, processing aids, fillers, rheology modifiers or structurants, opacifiers, pearlescent agents, pigments, anti-corrosion and/or anti-tarnishing agents, and mixtures thereof. While one of ordinary skill will generally be familiar with these adjuncts, a few of the adjuncts are described in more detail below.

The consumer product compositions may include surfactant. Surfactants may be useful for providing, for example, cleaning benefits. The compositions may comprise a surfactant system, which may contain one or more surfactants.

The compositions of the present disclosure may include from about 1% to about 70%, or from about 2% to about 60%, or from about 5% to about 50%, by weight of the composition, of a surfactant system. Liquid compositions may include from about 5% to about 40%, by weight of the composition, of a surfactant system. Compact formulations, including compact liquids, gels, and/or compositions suitable for a unit dose form, may include from about 25% to about 70%, or from about 30% to about 50%, by weight of the composition, of a surfactant system.

The surfactant system may include anionic surfactant, nonionic surfactant, zwitterionic surfactant, cationic surfactant, amphoteric surfactant, or combinations thereof. The surfactant system may include linear alkyl benzene sulfonate, alkyl ethoxylated sulfate, alkyl sulfate, nonionic surfactant such as ethoxylated alcohol, amine oxide, or mixtures thereof. The surfactants may be, at least in part, derived from natural sources, such as natural feedstock alcohols.

Suitable anionic surfactants may include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. The anionic surfactants may be linear, branched, or combinations thereof. Preferred surfactants include linear alkyl benzene sulfonate (LAS), alkyl ethoxylated sulfate (AES), alkyl sulfates (AS), or mixtures thereof. Other suitable anionic surfactants include branched modified alkyl benzene sulfonates (MLAS), methyl ester sulfonates (MES), sodium lauryl sulfate (SLS), sodium lauryl ether sulfate (SLES), and/or alkyl ethoxylated carboxylates (AEC). The anionic surfactants may be present in acid form, salt form, or mixtures thereof. The anionic surfactants may be neutralized, in part or in whole, for example, by an alkali metal (e.g., sodium) or an amine (e.g., monoethanolamine).

The surfactant system may include nonionic surfactant. Suitable nonionic surfactants include alkoxylated fatty alcohols, such as ethoxylated fatty alcohols. Other suitable nonionic surfactants include alkoxylated alkyl phenols, alkyl phenol condensates, mid-chain branched alcohols, mid-chain branched alkyl alkoxylates, alkylpolysaccharides (e.g., alkylpolyglycosides), polyhydroxy fatty acid amides, ether capped poly(oxyalkylated) alcohol surfactants, and mixtures thereof. The alkoxylate units may be ethyleneoxy units, propyleneoxy units, or mixtures thereof. The nonionic surfactants may be linear, branched (e.g., mid-chain branched), or a combination thereof. Specific nonionic surfactants may include alcohols having an average of from about 12 to about 16 carbons, and an average of from about 3 to about 9 ethoxy groups, such as C₁₂-C₁₄ EO7 nonionic surfactant.

Suitable zwitterionic surfactants may include any conventional zwitterionic surfactant, such as betaines, including alkyl dimethyl betaine and cocodimethyl amidopropyl betaine, C₈ to C₁₈ (for example from C₁₂ to C₁₈) amine oxides (e.g., C₁₂₋₁₄ dimethyl amine oxide), and/or sulfo and hydroxy betaines, such as N-alkyl-N,N-dimethylammino-1-propane sulfonate where the alkyl group can be C₈ to C₁₈, or from C₁₀ to C14. The zwitterionic surfactant may include amine oxide.

Depending on the formulation and/or the intended end-use, the composition may be substantially free of certain surfactants. For example, liquid fabric enhancer compositions, such as fabric softeners, may be substantially free of anionic surfactant, as such surfactants may negatively interact with cationic ingredients.

The consumer product compositions may include conditioning actives. Compositions that contain conditioning actives may provide softness, anti-wrinkle, anti-static, conditioning, anti-stretch, color, and/or appearance benefits.

Conditioning actives may be present at a level of from about 1% to about 99%, or from about 1% to about 35%, or from about 1% to about 20%, or from about 1% to about 15%, or from about 1% to about 10%, or from about 1% to about 6%, by weight of the composition. The composition may include from about 1%, or from about 2%, or from about 3%, to about 99%, or to about 75%, or to about 50%, or to about 40%, or to about 35%, or to about 30%, or to about 25%, or to about 20%, or to about 15%, or to about 10%, by weight of the composition, of conditioning active. The composition may include from about 5% to about 30%, by weight of the composition, of conditioning active.

Conditioning actives suitable for compositions of the present disclosure may include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof.

The composition may include a quaternary ammonium ester compound, a silicone, or combinations thereof, preferably a combination. The combined total amount of quaternary ammonium ester compound and silicone may be from about 5% to about 70%, or from about 6% to about 50%, or from about 7% to about 40%, or from about 10% to about 30%, or from about 15% to about 25%, by weight of the composition. The composition may include a quaternary ammonium ester compound and silicone in a weight ratio of from about 1:10 to about 10:1, or from about 1:5 to about 5:1, or from about 1:3 to about 1:3, or from about 1:2 to about 2:1, or about 1:1.5 to about 1.5:1, or about 1:1.

The composition may contain mixtures of different types of conditioning actives. The compositions of the present disclosure may contain a certain conditioning active but be substantially free of others. For example, the composition may be free of quaternary ammonium ester compounds, silicones, or both. The composition may comprise quaternary ammonium ester compounds but be substantially free of silicone. The composition may comprise silicone but be substantially free of quaternary ammonium ester compounds.

The compositions of the present disclosure may contain a rheology modifier and/or a structurant. Rheology modifiers may be used to “thicken” or “thin” liquid compositions to a desired viscosity. Structurants may be used to facilitate phase stability and/or to suspend or inhibit aggregation of particles or droplets in liquid compositions, such as the droplets of the emulsions as described herein. Suitable rheology modifiers and/or structurants may include non-polymeric crystalline hydroxyl functional structurants (including those based on hydrogenated castor oil), polymeric structuring agents, cellulosic fibers (for example, microfibrillated cellulose, which may be derived from a bacterial, fungal, or plant origin, including from wood), di-amido gellants, or combinations thereof.

The consumer product compositions made from the presently described methods may include free perfume. To provide a broader and more diverse scent profile, it may be desirable to include perfume raw materials in the free perfume of the consumer product composition that are not present in the silicone emulsion, and/or vice versa. For example, when the silicone emulsion comprises one or more perfume raw materials that comprise an aldehyde moiety, the free perfume of the consumer product composition may comprise one or more perfume raw materials that do not comprise an aldehyde moiety. Similarly, when the silicone emulsion comprises one or more perfume raw materials that comprise a ketone moiety, the free perfume of the consumer product composition may comprise one or more perfume raw materials that do not comprise a ketone moiety. The free perfume may include perfume raw materials that include aldehyde moieties, perfume raw materials that do not include aldehyde moieties, perfume raw materials that include ketone moieties, perfume raw materials that do not include ketone moieties, or mixtures thereof.

The base composition may be in the form of a liquid. The base composition may comprise water. The base composition may comprise from about 1% to about 99%, preferably from about 5% to about 98%, or from about 10% to about 95%, or from about 50% to about 95%, or from about 60% to about 95%, or from about 75% to about 95%, by weight of the base composition, of water.

The consumer product composition may be in the form of a liquid. The consumer product composition may comprise water. The consumer product composition may comprise from about 1% to about 99%, preferably from about 5% to about 98%, or from about 10% to about 95%, or from about 50% to about 95%, or from about 60% to about 95%, or from about 75% to about 95%, by weight of the consumer product composition, of water. Certain unit dose formulations may have relatively low amounts of water so as to not dissolve the water-soluble film; for example, the composition may comprise no more than about 20%, or no more than about 15%, or no more than about 12%, or no more than about 10%, by weight of the composition, of water.

The consumer product composition may be in a particulate form, such as a plurality of particulates. Individual particulates may have a mass from about 1 mg to about 1 g. The emulsion may be dispersed in a water-soluble carrier. The water-soluble carrier may be selected from the group consisting of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof. The water-soluble carrier may be a water-soluble polymer. The consumer product composition, when in particulate form, may comprise from about 25 wt % to about 99.99 wt % of the water-soluble carrier, and from about 0.01 wt % to about 50 wt % by weight the emulsion. The particulate form may be in the form of a bead or pastille.

### METHODS OF USING

The present disclosure also relates to a method of treating a surface, preferably where the surface is a fabric, hair, or skin, more preferably a fabric. The method may comprise the steps of contacting the surface with the composition according to the presence of water, optionally in the presence of water.

The processes of the present disclosure may include diluting the composition with water to form a treatment liquor, which may contact the surface to be treated. The composition may be diluted from 100-fold to 1000-fold, or from 200-fold to 900-fold, or from 300-fold to 800-fold, by water.

The contacting step may occur in the drum of an automatic washing machine. The contacting step may occur as part of, or shortly before, a wash cycle; for example, the consumer product may be a detergent composition or may be added substantially concurrently with a detergent composition. The contacting step may occur as part of a rinse cycle, which may follow a wash cycle; for example, the consumer product may be a fabric enhancer product, such as a liquid fabric enhancer product, and may contact the surface subsequent to the surface having been treated by a detergent product.

The contacting step may occur as a pretreatment step.

### Combinations

Specifically contemplated combinations of the disclosure are herein described in the following lettered paragraphs. These combinations are intended to be illustrative in nature and are not intended to be limiting.

A. A perfume/silicone emulsion composition (“emulsion composition”) comprising: an aminofunctional silicone, wherein the aminofunctional silicone comprises one or more primary amine moieties, and wherein the aminofunctional silicone is characterized by a total amine content of from about 0.05 to about 2.2; one or more emulsifiers; one or more perfume raw materials, wherein the one or more perfume raw materials comprises an aldehyde moiety, a ketone moiety, or combinations thereof; and water.

B. The perfume/silicone emulsion composition of paragraph A, wherein the emulsion composition is characterized by a pH of 7.0 or greater, preferably by a pH of from 7.0 to about 11, more preferably from about 8 to 11, wherein pH is measured as a 10% dilution of emulsion in deionized water (i.e., 10 parts by weight of emulsion, 90 parts by weight of deionized water).

C. The perfume/silicone emulsion composition of any of paragraphs A or B, wherein the aminofunctional silicone is characterized by a total amine content of from about 0.071 to about 2.14, or from about 0.071 to about 1.78, or from about 0.71 to about 1.43, or from about 0.14 to about 1.07, or from about 0.14 to about 0.71, or from about 0.21 to about 0.71, or from about 0.36 to about 0.71.

D. The perfume/silicone emulsion composition of any of paragraphs A-C, wherein the aminofunctional silicone is characterized by a primary amine content of from about 0.05 to about 2.2, preferably from about 0.071 to about 2.14, or from about 0.071 to about 1.78, or from about 0.71 to about 1.43, or from about 0.14 to about 1.07, or from about 0.14 to about 0.71, or from about 0.21 to about 0.71, or from about 0.36 to about 0.71.

E. The perfume/silicone emulsion composition of any of paragraphs A-D, wherein the aminofunctional silicone is characterized by a ratio of primary amine content to total amine content of from about 1:2 to about 1:1, preferably from about 1.2:2, more preferably from about 1.5:2, or even more preferably from about 1.8:2.

F. The perfume/silicone emulsion composition of any of paragraphs A-E, wherein the one or more emulsifier comprises a nonionic surfactant, preferably wherein the nonionic surfactant comprises an alkoxylated fatty alcohol.

G. The perfume/silicone emulsion composition of any of paragraphs A-F, wherein the one or more emulsifier is characterized by an HLB value of from about 5 to about 20, preferably from about 8 to about 16.

H. The perfume/silicone emulsion composition of any of paragraphs A-G, wherein the emulsifier comprises a first emulsifier and a second emulsifier that is different from the first emulsifier, preferably wherein the first emulsifier is a linear nonionic surfactant, and/or preferably wherein the second emulsifier is a branched nonionic surfactant.

I. The perfume/silicone emulsion composition of any of paragraphs A-H, wherein the one or more perfume raw materials is characterized by the following structure:

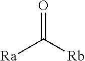

wherein Ra is selected from the group consisting of: C₃-C₁₈ alkyl, C₃-C₁₈ alkenyl, C₃-C₁₈ substituted alkyl,

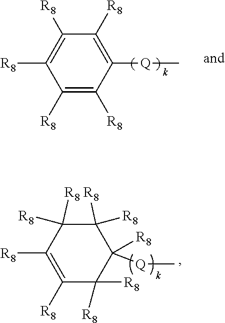

wherein each R₈ is independently selected from the group consisting of H, straight or branched chain C₌₁-C₈ alkyl, C₁-C₈ substituted alkyl, and C₁-C₂ alkoxy, k is an integer with value 0 or 1, and Q is an alkylene radical with from 2 to 8 carbon atoms; and wherein Rb is selected from H and —CH═CH—R₉, wherein R₉ is selected from H or a C₁-C₃ alkyl group.

J. The perfume/silicone emulsion composition of paragraph I, wherein Ra is selected from the group consisting of:

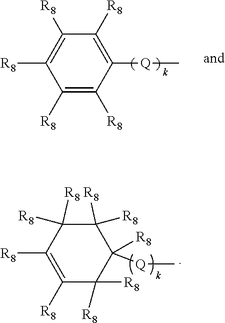

K. The perfume/silicone emulsion composition of any of paragraphs I or J, wherein at least two R₈ groups are fused to form a bicyclic structures, preferably a bicyclic structure selected from the group consisting of:

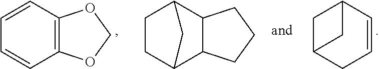

L. The perfume/silicone emulsion composition according to any of paragraphs I-K, wherein each Q is independently selected from

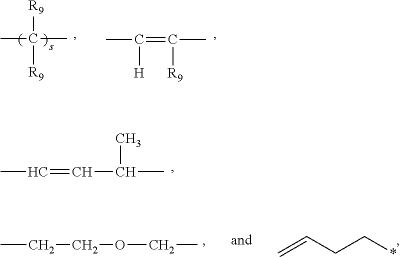

wherein s is an integer from 1 to 4, and wherein each R₉ is independently selected from H or C₁-C₃ alkyl group, and where * represents the end of the moiety linked to the Ra group, preferably wherein each Q is independently selected from

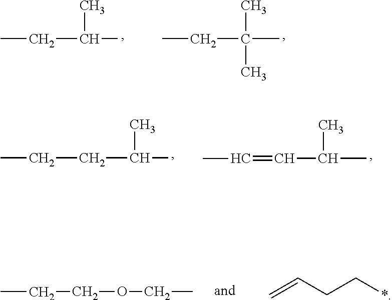

M. The perfume/silicone emulsion composition of any of paragraphs I-L, wherein Rb is H.

N. The perfume/silicone emulsion composition of any of paragraphs A-M, wherein the one or more perfume raw materials is characterized by the following structure:

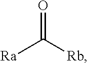

and wherein Ra and Rb are selected from one of the following combinations:
a. Ra is selected from the group consisting of: C₃-C₁₈ alkyl, C₃-C₁₈ alkenyl, and C₃-C₁₈ substituted alkyl; and Rb is H;
b. Ra is selected from

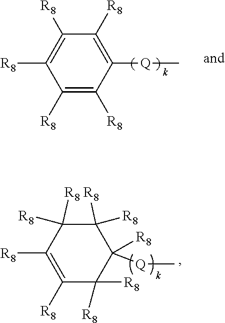

wherein k is 0, and wherein R₈ is selected from the group consisting of H, C₁-C₃ alkyl, and C₁-C₂ alkoxy; and Rb is 0;
c. Ra is selected from the group consisting of:

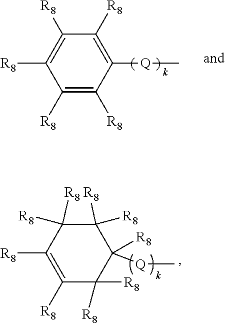

k is 1, R is selected from the group consisting of H, C₁-C₃ alkyl, and C₁-C₂ alkoxy, and Q is selected from the group consisting of:

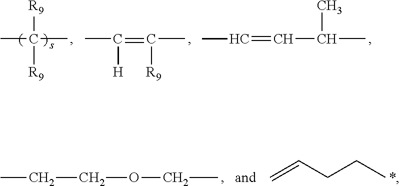

preferably Q is selected from

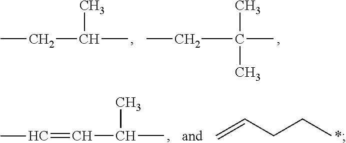

### and Rb is H;

d. Ra is selected from the group consisting of:

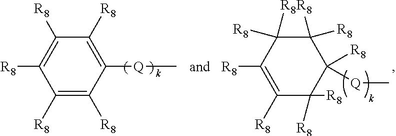

wherein k is 0, and Rb is —CH═CH—R₉,

O. The perfume/silicone emulsion composition of any of paragraphs A-N, wherein the one or more perfume raw materials are selected from the following:
a. oncidal, methyl nonyl acetaldehyde, adoxal, melanal, calypsone, or mixtures thereof;
b. cuminic aldehyde, benzaldehyde, anisic aldehyde, heliotropin, isocyclocitral, triplal/ligustral, 3,6-ivy carbaldehyde, ligustral, scentenal, or mixtures thereof;
c. satinaldehyde (jasmorange), otropal, cyclamen homoaldehyde, cyclamen aldehyde (cyclamal), lilial, canthoxal, floralozone, cinnemic aldehyde, or mixtures thereof;
d. delta-damascone, beta-damascone, alpha-damascone, nectaryl, or mixtures thereof;
e. vanillin, ethyl vanillin, or mixtures thereof; or
f. a combination of materials selected from at least two categories of a, b, c, d, and e.

P. The perfume/silicone emulsion composition of any of paragraphs A-O, wherein the aminofunctional silicone is characterized by the following formula:

[R₁R₂R₃SiO_{1/2}]₍ⱼ₊₂ₗ₊₂₎[R₄R₅SiO_{2/2}]ₘ[R₆SiO_{3/2}]ⱼ[SiO_{4/2}]ₗ

wherein
j is an integer from 0 to 150, preferably from 0 to 50, more preferably from 0 to 20;
m is an integer from 10 to 1500, preferably 10 to 1000, more preferably from 20 to 500;
l is an integer from 0 to 150, preferably from 1 to 150, more preferably from 0 to 50, most preferably from 0 to 20;
   with the provisio j+m+l equals an integer greater than or equal to 50;
each of R₁, R₂, R₃, R₄, R₅ and R₆ moieties is independently selected from the group consisting of H, OH, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl, C₁-C₃₂ alkoxy and C₁-C₃₂ substituted alkoxy, and X—Z, wherein at least one of the moieties R₁ through R₆=X—Z,
   preferably wherein each R₁₋₆ is independently selected from the group consisting of OH, C₁-C₂ alkyl, C₁-C₂ substituted alkyl, C₁-C₂ alkoxy, C₁-C₂ substituted alkoxy, and X—Z;
wherein each X is independently a substituted or unsubstituted divalent alkylene or alkylidene radical comprising 2-12 carbon atoms, preferably each X is independently a substituted or unsubstituted divalent alkylene or alkylidene radical comprising 2-6 carbon atoms, most preferably each X is independently a substituted or unsubstituted divalent alkylene or alkylidene radical comprising 2-4 carbon atoms;

wherein each Z is a moiety comprising the one or more primary amine moieties,
preferably wherein each Z is independently selected from the group —NH₂, —N(H)—X—NH₂, or a mixture thereof.

Q. The perfume/silicone emulsion composition of any preceding claim, wherein the emulsion comprises from about 10% to about 70%, or from about 25% to about 65%, or from about 50% to about 65%, by weight of the silicone emulsion, of the aminofunctional silicone.

R. The perfume/silicone emulsion composition of any of paragraphs A-Q, wherein the emulsion comprises from about 30% to about 90%, or from about 35% to about 75%, or from about 35% to about 50%, by weight of the emulsion, of water.

S. The perfume/silicone emulsion composition of any of paragraphs A-R, wherein the emulsion is characterized by a viscosity of from about 10 to about 500 Pa·s, preferably from about 20 to about 400 Pa·s, more preferably from about 25 to about 300 Pa·s, even more preferably from about 100 to about 300 Pa·s, measured at 0.1 rad/s and 25° C.

T. The perfume/silicone emulsion composition of any of paragraphs A-S, wherein the emulsion comprises a plurality of droplets, where the plurality of droplets is characterized by a mean diameter of from about 1 micron to about 5 microns.

U. A method of making the perfume/silicone emulsion composition of any of paragraphs A-T, the method comprising the steps of mixing the aminofunctional silicone, the one or more emulsifiers, and the one or more perfume raw materials in the presence of the water.

V. A consumer product composition comprising: the perfume/silicone emulsion composition according to any of paragraphs A-T; and a consumer product adjunct.

W. The consumer product composition according to paragraph V, wherein the consumer product adjunct is selected from an amine, a surfactant system, a water-binding agent, a sulfite, fatty acids and/or salts thereof, enzymes, encapsulated benefit agents, soil release polymers, hueing agents, builders, chelating agents, dye transfer inhibiting agents, dispersants, enzyme stabilizers, catalytic materials, bleaching agents, bleach catalysts, bleach activators, polymeric dispersing agents, soil removal/anti-redeposition agents, polymeric dispersing agents, polymeric grease cleaning agents, brighteners, suds suppressors, dyes, hueing agents, free perfume, structure elasticizing agents, fabric softening agents, carriers, fillers, hydrotropes, organic solvents, anti-microbial agents and/or preservatives, neutralizers and/or pH adjusting agents, processing aids, fillers, rheology modifiers or structurants, opacifiers, pearlescent agents, pigments, anti-corrosion and/or anti-tarnishing agents, and mixtures thereof.

X. The consumer product composition according to any of paragraphs U-W, wherein the consumer product adjunct comprises free perfume, preferable free perfume that comprises perfume raw materials that do not comprise an aldehyde moiety.

Y. The consumer product composition according to any of paragraphs U-X, wherein the consumer product composition is in the form of a liquid composition, a granular composition, a single-compartment pouch, a multi-compartment pouch, a dissolvable sheet, a pastille or bead, a fibrous article, a tablet, a bar, a flake, a non-woven sheet, or a mixture thereof.

Z. The consumer product composition according to any of paragraphs U-Y, wherein the consumer product composition is a household care composition, preferably a household care composition selected from the group consisting of a fabric and home care product, a beauty care product, or a mixture thereof, wherein if said consumer product is a fabric and home care product, preferably the fabric and home care product is selected from a laundry detergent composition, a fabric conditioning composition, a laundry and rinse additive, a fabric pre-treatment composition, a fabric refresher composition, or a mixture thereof; and wherein if the consumer product is a beauty care product, preferably the beauty care product is selected from a hair treatment product, a skin care product, a shave care product, a personal cleansing product, a deodorant and/or antiperspirant, or a mixture thereof.

AA. A method of making the consumer product according to any of paragraphs U-Z, the method comprising the step of combining the emulsion with the consumer product adjunct.

BB. A method of treating a surface, preferably wherein the surface is a fabric, the method comprising the steps of contacting the surface with the consumer product composition according to any of paragraphs U-Z, optionally in the presence of water.

### Test Methods

### Fabric Treatment Method

Test fabrics are treated in a miniwasher according to the following procedure.

Five full-sized cotton terry cloths (30 cm×30 cm) (or their equivalent: e.g., ten half-sized terries, or twenty quarter-sized terries) are used for each test leg. The terries are pre-conditioned with three cycles of liquid detergent and fabric softener, both of which are free of perfumes.

Weigh out desired number of detergent doses into plastic cups and secure with lids such that each dose of detergent is 9.98 g (+/−0.02 g) for each treatment for each cycle. For example, if five treatments of one wash cycle is being run, five doses of detergent would be needed, one dose for each treatment. Repeat the same process with the liquid fabric softener samples such that each dose is 5.68 g (+/−0.02 g) for each treatment.

For the test, the following treatment conditions are used:
Machine Type: Miniwasher (designed to mimic top-loader conditions)
Machine Cycle: 80 spm (normal)
Wash Temp: approx. 30.6° C. (87° F.)
Rinse Temp: approx. 15.6° C. (60° F.)
Water Hardness: about 100 ppm (6 gpg)
Wash Time: 12 mins
Rinse Time: 2 mins
Water Volume: 2 gal fill (˜8 L)
Dry Type: Electric

Turn on the mini-washer and water mixing station. Set the water mixing station using the water specifications mentioned above. Fill each drum of the mini-washer to the 2 gal line, adding the detergent to each drum respectively while the drum is filling. Rinse the cup with the water coming into the drum such that all of the detergent is added to and well dispersed throughout the drum. Once the drums are filled with water and the dispersed detergent, add the fabrics and set the agitation time to 12 mins. At the end of the agitation time, set the spin timer to 2 mins to allow the water to spin out of the drum. Once the spin cycle is complete, remove the fabrics from each drum ensuring each fabric bundle remains separate from the others. Start the fill cycle again using the water specifications for the rinse cycle to the 2 gal line (the water mixing station should automatically switch to the rinse water specifications). During the fill cycle, add the liquid fabric softener dose to each drum respectively. Ensure complete addition and dispersion of the liquid fabric softener composition by rinsing the dosing cup with the incoming water. Once the drum is filled with water and the dispersed fabric softener, the fabrics can be added back to each respective drum. Set the agitation cycle to 2 mins and allow to run. After the agitation is complete, set the spin cycle to 2 mins to allow all of the water to spin out. After completing the spin cycle, each fabric bundle is placed into a separate electric dryer and dried on a high/cotton setting. Once the fabrics are dry, they are placed in a constant temperature/constant relative humidity room set at 75 F and 50% relative humidity for at least 4 hrs (preferably overnight) to equilibrate.

### Headspace Analysis on Fabric

To prepare the treated fabric for analysis, cut one 2.54 cm×5.08 cm (1 inch×2 inch) cotton swatch from the cotton terry that is prepared and treated according to the above methods. Place each piece in a 20 mL headspace vial. Re-equilibrate for four hours in a Controlled Humidity and Temperature room (21 C/50% humidity). After the four hours the vials are capped and analyzed via Headspace solid phase micro-extraction/Gas Chromatography/Mass Spectrometry.

The equipment used for analysis is as follows: Gas Chromatograph 7890B equipped with a Mass Selective Detector (5977B) (MSD) and Chemstation quantitation package; Gerstel Multi-Purpose sampler equipped with a solid phase micro-extraction (SPME) probe or similar system; Divinylbenzene/Carboxen/Polydimethylsiloxane SPME fiber from Supleco part #57298-U (or similar fiber); column with 30 m×0.25 mm nominal diameter, 0.25 μm film thickness, J&W 122-5532UI DB-5; 20 mL headspace vials.

The Gerstel auto sampler parameters are as follows: SPME—from Incubator; Incubation Temperature—65° C.; Incubation Time—10.00 min SAMPLE PARAMETERS; Vial Penetration—22.00 mm; Extraction Time—5.00 min; Inj. Penetration—54.00 mm; Desorption Time—300 s.

The GC oven parameters are as follows for the Front SS Inlet He: Mode—Splitless; Heater—270° C.; GC Run Time—14.28 min. For the Oven: Initial temp.—40° C.; Hold Time—0.5 min; Heating Program—Rate of 17° C./min, Temp of 270° C., Hold Time of 0.25.

The MSD parameters are as follows: Run in scan mode with a minimum range of 35 to 350 m/z; calibration curves are generated from the standards perfume material; Chemstation software (or similar quantitation software) calculates this amount using the quantitation software for each perfume component.

### Headspace Analysis Above Emulsions

Emulsions may undergo headspace analysis that is substantially similar to the method described above (Headspace Analysis on Fabrics), with the following differences.

The emulsion is prepared for analysis by placing 1 g of emulsion in a 20 mL headspace vial. The Gerstel Multi-Purpose sample is equipped with a Static Headspace unit.

The sampler parameters are as follows. For the syringe settings: syringe—1.0 mL; syringe temperature—60 C; flush time—60 s. For the sample parameters: headspace—from Tray; incubation time—0.00 min; inj. volume—1000.0 uL; inj. speed—200.00 uL/s; pullup delay—5 s; fill volume—1000.0; fill strokes—3; fill speed—200.00 uL/s; pre-inj. delay—0 s; post-inj. delay—0 s; inj. penetration—25.00 mm; sample tray type—VT32-20; vial penetration—22.00 mm.

The GC oven parameters are as follows: for the Front SS inlet He, mode—Split 5 to 1; heater—270 C; GC run time—14.8 min. Same oven settings as above.

The MSD parameters are as follows: run in scan mode with a minimum range of 35 to 350 m/z (range may be greater). Area Response for the target ion for each PRM in a PDMS control is measured. Area Response for the target ion for each PRM in the emulsion sample is measured. The Area Response for each PRM in the emulsion may be normalized vs. the Area Response for each PRM in the PDMS control.

### Color Change Measurements

The emulsions may be tested for color changes according to the following procedure.

The reflectance spectra and color measurements, including L*, a*, and b* are made using the LabScan XE reflectance spectrophotometer (HunterLabs, Reston, Va.; D65 illumination, 10 observer, UV light excluded). L*, a* and b* values for emulsions are measured at time t=0 and 7 days after mixing in the PRM.

The total color change (ΔE) of an emulsion is calculated based on the data collected at each time point t using the following equation:

ΔEₜ=((L*_{c}−L*ₛ)²+(a*_{c}−a*ₛ)²+(b*_{c}−b*ₛ)²)^{1/2}

wherein the subscripts c and s respectively refer to the control, i.e., the emulsion with nil PRM, and the sample, i.e., the emulsion with respective aldehyde/ketone PRM, where the values used to calculate ΔEₜ are those at the corresponding time points t (0, 7 days).

The desired PRM is slowly added to a sample of an aminofunctional silicone (for example, in relative amounts sufficient to provide 1:1 molar equivalence of primary amine groups in the silicone to aldehyde or ketone groups of the perfume) in a jar with overhead mixing with a four-blade impeller and gently mixed for 15 minutes. The emulsion mixture is placed into 50 mL (25 cm²) cell culture flask with red standard screw cap (Lot #E1802380, sterile, CELLSTAR®). At t=0 and after 7 days, color appearance of each emulsion sample is measured on a LabScan XE reflectance spectrophotometer (HunterLabs, Reston, Va.; D65 illumination, 100 observer, UV light excluded) utilizing the translucent emulsion sample set. Step by step instructions are found in Hunter Labs Applications Note, Vol. 11, No. 3, 2008.

1. Set the mode to reflectance.

2. Standardize the instrument with the special port insert in place.

3. Perform the diagnostic test for green tile.

4. Place the sample and measure the reflectance.

Samples were placed in a temperature-controlled room (30° C.) over the 7 days period, and data is again collected at the end of the storage period.

The experiment may be repeated with additional perfume aldehyde/ketone PRMs.

### Determination of Amine Content and % Nitrogen

Total amine content, primary amine content, and/or % nitrogen of an aminofunctional silicone is determined according to the following method. More specifically, this method is used to determine the primary, secondary and tertiary amine values (meq/g) which are defined as the milliequivalents of amine functionality (primary, secondary and tertiary) present in one gram of a sample.

The method is based on compendial method ASTM D2074-07, which should be used to supplement this method if necessary. In broad stokes, a sample is dissolved in isopropyl alcohol and is titrated to a bromophenol blue end point using a standardized HC solution.

The following materials are used: 0.1N Hydrochloric Acid in isopropyl alcohol (CAS 7647-01-1, 67-63-0; 99.5%; ex Fisher Scientific); Isopropyl Alcohol (CAS #67-63-0; 99%; ex EMD); Phenyl Isothiocyanate (CAS #103-72-0; 98%; ex Sigma Aldrich); Salicylaldehyde (CAS #90-02-8; 98%; ex Sigma Aldrich); Bromophenol Blue Indicator (0.1 wt % solution in ethanol or isopropyl alcohol; ex. Fisher Scientific).

Each of the following titrations should be repeated a total of three times. Furthermore, titrant volumes must be determined empirically. Titrant volumes should be between 1 and 20 mL. If titrant volumes are less than 1 mL, weigh more sample. If samples are more than 20 mL, weigh less sample. A buret such as Metrohm Dosimat 775 or equivalent may be used in the titrations. Regarding the yellow end point of the titrations—the yellow may fade back to green, but if it is a bright clear yellow, this is to be disregarded if additional 0.1N HCl does not change the original color.

A. Titration for Total Amine Content

Melt the sample (typically 100% active) in a water bath if it is not already a liquid. Mix thoroughly and accurately weigh out between 0.5 grams and 1.0 grams into a 250 mL Erlenmeyer flask (wide mouth; alkali resistant). Record the weight to four decimal places.

To the flask, add 50 mL of isopropyl alcohol. Add 0.5 mL of bromophenol blue indicator. Titrate with 0.1N HCl solution while swirling until it reaches the yellow end point. Record the volume of HCl used as V_{1,2,3}.

B. Titration for Secondary and Tertiary Amine Content

Melt the sample (typically 100% active) in a water bath if it is not already a liquid. Mix thoroughly and accurately weigh out 1.0 grams into two 250 Erlenmeyer flasks. Record the weight to four decimal places. Mark the flasks S and T, respectively. To each flask, add 50 mL of isopropyl alcohol.

To flask S, add 1 mL of salicylaldehyde. Stir the solution (with a magnetic stir bar) for 30 minutes. Add 0.5 mL of bromophenol blue indicator solution and titrate while stirring with 0.1N HCl to a yellow end point. Record volume of HCl used as V_{2&3}.

To flask T, add 1 mL of phenyl isothiocyanate. Stir the solution (with a magnetic stir bar) for 30 minutes. Add 0.5 mL of bromophenol blue indicator solution and titrate while stirring with 0.1N HCl to a yellow end point. Record volume of HCl used as V₃.

C. Calculations for Amine Content

The variables in the calculations described below correspond to the following:
V: HCl required for titration of specimen in mL
N: normality of the HCl solution
S: specimen weight in grams (g)
meq/g: milliequivalents/gram
Total: Total Amine Value
AS: Amine value of the secondary and tertiary amine groups
TA: Tertiary Amine Value

Based on the measurements obtained related to the above titrations, the following calculations are used to determine the various amine contents.

$$Total Amine Value ( Total ) = \frac{( {V}_{1 , 2 , 3} * N ) ( \text{meq/g} )}{S}$$

$$Secondary and Tertiary Amine Value ( AS ) = \frac{( {V}_{2 , {3}^{*}} N ) ( \text{meq/g} )}{S}$$

$$Tertiary Amine Value ( TA ) = \frac{( {V}_{{3}^{*}} N ) ( \text{meq/g} )}{S}$$

$$Secondary Amine Value = ( A S - T A )$$

$$Primary Amine Value = ( Total - AS )$$

D. Calculation of Nitrogen wt %

To determine the wt % of nitrogen in an aminofunctional silicone based on the amine content, use the following calculation.

The weight percentage of nitrogen in a compound can be calculated from the amine value (in meq/g) as follows:

(Amine Value/1000)×(MW of Nitrogen)×100=wt % Nitrogen

As an example, dimethylethanolamine has an amine value of 11.2 (in meq/g). Its weight percent of nitrogen (15.7 wt %) is as follows:

(11.2/1000)×(14.01)×100=15.7 wt % nitrogen

The following table shows wt % of nitrogen and equivalent amine values.

| Wt % Nitrogen | Amine Value (meq/g) |
|---|---|
| 0.1 | 0.071 |
| 0.2 | 0.14 |
| 0.3 | 0.21 |
| 0.5 | 0.36 |
| 0.7 | 0.50 |
| 0.8 | 0.57 |
| 1.0 | 0.71 |
| 1.5 | 1.07 |
| 2.0 | 1.43 |
| 2.5 | 1.78 |
| 3.0 | 2.14 |
| 3.5 | 2.50 |

E. Standard

To confirm quality control of the method, a suitable standard may be run—for example, dimethylethanol amine (a tertiary amine; 99.5%; available from Sigma Aldrich). For this particular amine, total amine and tertiary amine content should be 11.2±0.2 meq/g. Primary and Secondary amine content should be <0.1 meq/g.

### Viscosity Test Method

The following test method is used to determine the viscosity of an aminofunctional silicone and/or an emulsion containing such a silicone.

A preliminary estimate of the sample viscosity at 25° C. is used to select the appropriate instrument geometry to be used during the final viscosity measurement analyses, which are conducted on a model AR-G2 Rheometer (manufactured by TA Instruments Corp., New Castle, Del., USA). A preliminary estimate of the sample viscosity may be obtained by using a Brookfield Viscometer (Brookfield Engineering Laboratories Inc., Middleboro, Mass., USA). The selection of geometry for use on the AR-G2 Rheometer is determined in accordance with the following table:

AR-G2 Geometry Selection

| Preliminary Estimate of | |
|---|---|
| Sample Viscosity | AR-G2 Geometry and Plate Size |
| >1000 Pa*s | 25 mm parallel plate |
| 1 to 1000 Pa*s | 40 mm parallel plate |
| >Water-thin to <1 Pa*s | 60 mm parellel plate |
| Water-thin | Couette / Cup and Bob |

The geometry attached to the instrument, the instrument is mapped, the gap distance is zeroed, and the instrument temperature is set to 25° C. The measurement mode is selected as Stiff Mode when using parallel plates, or to Soft mode when using the couett cup and bob geometry. Sample material is mounted into the sample holding geometry e.g., the base plate. The minimum gap distance allowable between the base plate and the selected geometry is 10× the diameter of the largest common particle present in sample. If there are common particles in the sample which have a diameter greater than 100 μm (as determined microscopically), then the gap value is set to 10× the diameter of the largest common particle, otherwise the gap distance is set to the default value of 1000 μm (ie 1 mm). The selected geometry is lowered to the appropriate gap and a plastic tool is used to trim off any excess sample material. The sample material is allowed to equilibrate to the temperature of the instrument. Three rheological measurement analyses are conducted, namely: Flow Curve, Stress Sweep, and Frequency Sweep, using the following selections and settings:
Flow Curve: select Stepped Flow 0.01 to 100; 10 pts/decade; shear stress; constant time 20; average last 10.
Stress Sweep: set the Stress Range as 0.01 to 100 Pa; set the Frequency at 1 rad/s.
Frequency Sweep: Set the Angular Frequency Range as 0.1 to 100.

To ensure that the analysis is conducted within the Linear Viscoelastic Region set the Stress value at a third of the stress value that was present when G′ started to degrade during the prior Stress Sweep analysis.

The viscosity value for the test material obtained at 25° C. is reported, for example at 0.1 rad/s.

### Particle/Droplet Size

The droplet size for the siloxane compounds are analyzed as the emulsion and in the fabric softener utilizing a Horiba, Partica, Laser Scattering, Particle Size Distribution Analyzer LA-950V2 with a static quartz cell and operated in accordance with the manufacturer's instructions.

### HLB Value of Nonionic Surfactants

Nonionic surfactants can be classified by the balance between the hydrophilic and lipophilic moieties in the surfactant molecule. The hydrophile-lipophile balance (HLB) scale devised by Griffin in 1949 is a scale from 0-20 (20 being Hydrophilic) used to characterize the nature of surfactants. The HLB of a surfactant may be calculated as follows:

HLB=20*Mh/A

where Mh is the molecular of the hydrophilic portion of the molecule, and M is the molecular mass of the whole molecule, giving a result on a scale of 0 to 20. An HLB value of 0 corresponds to a completely lipophilic/hydrophobic molecule, and a value of 20 corresponds to a completely hydrophilic/lipophobic molecule. See Griffin, W. C. Calculation of HLB values of Nonionic Surfactants, J. Soc. Cosmet. Chem. 1954, 5, 249-256. The HLB values for commonly-used surfactants are readily available in the literature (e.g., HLB Index in McCutcheon's Emulsifiers and Detergents, MC Publishing Co., 2004). The HLB value for a mixture of surfactants can be calculated as a weighted average of the HLB values of the surfactants.

### EXAMPLES

The examples provided below are intended to be illustrative in nature and are not intended to be limiting.

### Example 1. Exemplary Method of Making a Perfume/Silicone Emulsion

100 grams of an aminofunctional silicone is provided. The aminofunctional silicone is KF-8003, supplied by Shin-Etsu, and has the following empirical structure:

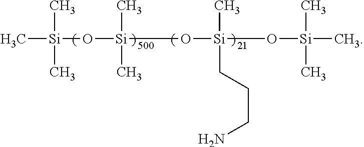

The 100 grams of aminofunctional silicone is mixed with 2.5 grams of a nonionic emulsifier (Tergitol 15-s-9 supplied by Dow Chemical Company, Midland, Mich.) and 2 grams of a second emulsifier (Surfonic L24-9 supplied by Sasol Chemicals, West Lake, La.), using an IKA overhead mixer set to 250 rpm.

10 grams of water is slowly added and mixed for 15 minutes. Mixing speed is increased slowly as viscosity of the mixture increases. 15 grams of additional water is added slowly while mixing for another 10 minutes at a speed between 300-400 rpm. Mixing speed is lowered if the viscosity of mixture decreases. 10.5 grams of additional water slowly added while continuing to mix for another 10 minutes. Mixing is continued for another 30 minutes at a speed of about 250 rpm.

The pH of the mixture is adjusted to about 8. The resulting amino silicone emulsion is analyzed for particle size using Horiba using the static cell. For particle size measurement, the emulsion is diluted to 0.1 wt % emulsion in deionized water (e.g., 0.1 wt parts emulsion, 99.99 wt parts DI water).

The following perfume aldehydes are mixed together in the (equal) molar ratio shown in the Table 1 to make the “Lilial Accord.”

TABLE 1

| | | FGMW | | |
|---|---|---|---|---|
| Lilial Accord | Wt (g) | (g/mol) | mol | Equiv. |
| Lilial | 2.70 | 204.313 | 0.0132 | 0.25 |
| cyclamal | 2.51 | 190.28 | 0.0132 | 0.25 |
| floralozone | 2.51 | 190.28 | 0.0132 | 0.25 |
| canthoxal | 2.35 | 178.23 | 0.0132 | 0.25 |

1.51 g of the Lilial Accord mixture (to achieve 1:1 equivalence of amine groups in the silicone to aldehyde group of the perfume) is slowly added to 25 g of the aminofunctional silicone emulsion in a jar with overhead mixing with a four-blade impeller and gently mixed for 10 minutes.

### Example 2. Headspace Analysis of Emulsion

Headspace analysis data is obtained for the emulsion of Example 1. The amount of PRMs found in the headspace is generally much less than the amount found in the headspace of a comparative emulsion containing the PRMs and a non-aminofunctional silicone (PDMS). This indicates that the PRMs and aminofunctional silicones are associating in a way such that the PRMs are not as freely released to the environment from the emulsion.

As a comparative example, an emulsion containing an aminofunctional silicone and aphermate, an ester-containing PRM, is made; the headspace is analyzed. A substantial amount of aphermate is found in the headspace, indicating that the association of the aminofunctional silicone and the ester-containing PRM is not as strong as with certain aldehydic PRMs.

### Example 3. Method of Making a Consumer Product with a Perfume/Silicone Emulsion

A consumer product (specifically, a liquid fabric softener composition) that includes a perfume/silicone emulsion is made according to the following method.

A base composition suitable for making a liquid fabric softener product is provided. The base composition includes a quaternary ammonium ester compound as a softening active. To the base composition, the following ingredients are added in this order: water, neat perfume (if any), perfume/silicone emulsion (for example, an emulsion according to Example 1), deposition aids and/or structurant (if any).

The raw materials are mixed with the base composition as they are being added using an overhead mixer 4 blade impellers. The sample is mixed for at least 5 mins at high speeds after each addition of silicone mixture and deposition aids (if any) to ensure good dispersion. Adjust the speed of mixing as needed during the making process to ensure all the material are being mixed in thoroughly to make a homogenous mixture.

Measure the pH of the sample using pH paper. If the pH is greater than 3, add 1N HCl to the sample until a pH of about 3 is reached.

Table 2 shows an exemplary liquid fabric softener composition that may be made according to this example. For testing purposes, it may be preferred to make a composition having 0% neat perfume, so that the level of PRMs delivered via the perfume/silicone emulsion may be more easily assessed. For products to be sold to consumers, it may be preferred to include from 0.5-5 wt % of neat perfume, to provide a richer olfactory experience.

TABLE 2

| Ingredient | Wt % |
|---|---|
| Softener active¹ | 9.5% |
| Neat perfume | 0% |
| Silicone Emulsion | 0.3% |
| (based on PRM active) | |
| Deposition aids / | 0.14% |
| Structurant | |
| Water | Balance |

¹N,N-bis(hydroxyethyl)-N,N-dimethyl ammonium chloride fatty acid ester, produced from C12-C18 fatty acid mixture (REWOQUAT CI-DEEDMAC, ex Evonik)

### Example 4. Fabric Headspace Measurements

To test the efficacy of consumer products made with emulsions according to the present disclosure, test fabrics are treated according to the Fabric Treatment Method provided in the Test Methods section. The test fabrics are treated with a liquid fabric softener composition generally according to Example 3, which is made using a perfume/silicone emulsion generally according to Example 1. That being said, the perfume raw materials that are added to the aminofunctional silicone are varied so that a variety of PRMs (and resulting emulsions, products, and/or treated fabrics) can be evaluated.

After treatment, the fabrics undergo headspace analysis according to the Headspace Analysis on Fabric procedure provided in the Test Methods section above. Results are provided in Tables 3 and 4 below.

A. Aldehyde PRMs

Table 3 shows the results related to various aldehyde-containing PRMs. The first column of results provides fabric headspace results that are indexed to cyclamal in combination with an aminofunctional silicone according to the present disclosure, where the amount of cyclamal in the tested headspace is equal to 1.0 (“Fabric Headspace Index 1”); a value of at least 0.4 is preferred, or at least 0.5, or at least 0.8, or at least 0.9, or at least 1.0.

The second column of results provides fabric headspace results that are indexed to that of a fabric treated with the indicated PRM in combination with anon-aminofunctional silicone (e.g., not according to the present disclosure), where the amount of PRM in the comparative headspace is equal to 1.0 (“Fabric Headspace Index 2”); a value of at least 2 is preferred, or at least 3, or at least 5, or at least 10. “ND” means the PRM was not detected in the given test.

TABLE 3

| | Fabric | Fabric |
|---|---|---|
| | Headspace | Headspace |
| | Index 1 | Index 2 |
| PRM | (cyclamal = 1.0) | (neat PRM = 1) |
| ONCIDAL | 14.4 | 287 |
| JASMORANGE | 13.5 | 18 |
| CUMINIC ALDEHYDE | 12.8 | 597 |
| BENZALDEHYDE | 12.8 | 320 |
| OTRAPAL | 9.9 | 13 |
| ISO CYCLO CITRAL | 8.5 | 7663 |
| SILVIAL | 7.2 | 2 |
| VERNALDEHYDE | 6.8 | 6114 |
| CYCLAL C/TRIPLAL | 5.5 | 87 |
| VERTOLIFF | 4.2 | 962 |
| PRECYCLAMONE B | 3.8 | 28 |
| METHYL NONYL | 3.8 | 4 |
| ACETALDEHYDE | | |
| ANISIC ALDEHYDE | 3.1 | 2967 |
| FLORALOZONE | 3.0 | 29 |
| ADOXAL | 2.6 | 8 |
| INTRELEVEN ALDEHYDE/ C11 | 2.6 | 4 |
| LIGUSTRAL | 2.1 | 1915 |
| MELONAL | 1.5 | 69 |
| CINNAMIC ALDEHYDE | 1.3 | 1186 |
| HELIOTROPIN (fused ring) | 1.3 | 53 |
| CYCLAMAL (avg.) | 1.0 | 7 |
| CALYPSONE | 0.9 | 64 |
| CITRONELLAL | 0.9 | 18 |
| LILIAL | 0.9 | 2 |
| PINO ACETALDEHYDE | 0.8 | 749 |
| FLORHYDRAL | 0.7 | 140 |
| FLORAL SUPER | 0.5 | 7 |
| CANTHOXAL | 0.4 | 4 |
| LIMOXAL | 0.2 | 11 |
| DUPICAL | 0.2 | 3 |
| SCENTENAL (fused ring) | 0.0 | 3 |
| TANGERINAL | 0.0 | 3 |
| CASCAVERT | 0.0 | 1 |
| TANS-4-DECENAL | ND | ND |

Additionally, vanillin and ethyl vanillin are also tested according to the above procedure. Vanillin and ethyl vanillin may be characterized as phenolic aldehydes, each having both an aldehyde moiety and a phenol moiety. Due to limitations of the headspace analysis method, however, PRMs having hydroxyl moieties (including phenol moieties) are not well detected. Thus, vanillin and ethyl vanillin are not substantially detected by the provided headspace analysis method. That being said, internal experts report being able to smell the distinctive odors of vanillin and ethyl vanillin on fabrics treated with a product containing emulsions according to the present disclosure that included those PRMs, indicating effective deposition and release of those PRMs onto the treated fabrics.

B. Ketone PRMs

Table 4 shows the results related to various ketone-containing PRMs. The first column of results provides fabric headspace results that are indexed to that of a fabric treated with the PRM in combination with a non-aminofunctional silicone (e.g., not according to the present disclosure), where the amount of PRM in the comparative headspace is equal to 1.0 (“Fabric Headspace Index 2”); a value of at least 2 is preferred, or at least 3, or at least 5, or at least 10.

The second column of results provides fabric headspace results that are indexed to delta-damascone in combination with an aminofunctional silicone according to the present disclosure, where the amount of delta-damascone in the tested headspace is equal to 1.0 (“Fabric Headspace Index 3”); a value of at least 0.02, or at least 0.05, or at least 0.1 is preferred.

To provide a relative comparison to the aldehydes in Table 3, cyclamal (an aldehydic PRM) is included in Table 4 and marked with an asterisk (*). For both columns, “ND” means the PRM was not detected in the given test.

TABLE 4

| | Fabric | Fabric |
|---|---|---|
| | Headspace | Headspace |
| | Index 2 | Index 3 (Delta- |
| PRM | (PRM = 1) | Damascone = 1.0) |
| DELTA DAMASCONE | 348 | 1.00 |
| BETA DAMASCONE | 485 | 0.83 |
| ALPHA DAMASCONE | 571 | 0.72 |
| Cyclamal (aldehyde) * | 7 | 0.19 |
| NECTARYL | 4 | 0.18 |
| TOFFETONE | 0 | 0.07 |
| GALBASCONE | 18 | 0.06 |
| FLEURAMONE | 2 | 0.06 |
| DIHYDRO- BETA IONONE | 1 | 0.05 |
| BETA- IONONE | 4 | 0.05 |
| RASBERRY KETONE | 1 | 0.03 |
| METHYL ETHER | | |
| ORIVONE | 36 | 0.02 |
| GALBANIFF | 2 | 0.01 |
| CASHMERAN | 2 | 0.01 |
| IONONE ALPHA | 2 | 0.01 |
| KOAVONE | 12 | 0.01 |
| L CARVONE | 15 | 0.00 |
| PARA-METHOXY | 1 | 0.00 |
| ACETOPHENONE | | |
| ISO MENTHONE (sterics) | 7 | 0.00 |
| TAMISONE | 7 | 0.00 |
| METHYL HEXYL KETONE | 7 | 0.00 |
| BENZYL ACETONE | 2 | 0.00 |
| CAMPHOR GUM | 2 | 0.00 |
| PARA-METHYL | ND | ND |
| ACETOPHENONE | | |
| HERBAC | ND | ND |
| FRESKOMENTHE (stearics) | ND | ND |
| METHYL AMYL KETONE | ND | ND |
| METHYL HEPTANONE | ND | ND |

### Example 5. Effect of pH on Perfume/Silicone Emulsions

Perfume/silicone emulsions are prepared using a representative aldehyde PRM (lilial) and a representative ketone PRM (delta-damascone), as well as a representative aminofunctional silicone (KF-8003, ex Shin-Etsu). The observed emulsions have various pHs, adjusted, if at all, at different points of the emulsion-making process. The emulsions are visually assessed for color after 24 hours, for stability/viscosity, and for the time taken to reach equilibrium, based on headspace analysis of emulsion samples taken at various time intervals. In general, less color change, lower viscosities, and faster times to equilibrium are all preferred for ease and consistency of processing the emulsions into a consumer product.

Results are provided in Table 5.

TABLE 5

| | | | Time to Equilibrium | | | |
|---|---|---|---|---|---|---|
| | | Vis- | | | Delta- | |
| Emulsion pH | Color at T = 24 h | cosity | Lilial | | Damascone | |
| pH 10: | Good | Stable | <15 | min | 2 | h |
| no adjustment | (little change) | | | | | |
| | vs no pH adj. | | | | | |
| pH 7: | Some yellowing | More | <15 | min | >2 | h |
| Adjusted before | vs no pH adj. | viscous | | | | |
| PRM addition | | | | | | |
| pH 7: | Some yellowing | More | <15 | min | >2 | h |
| Adjusted after | vs no pH adj. | viscous | | | | |
| PRM addition | | | | | | |
| pH 4: | Much more | Very | 5 | h | 16 | h |
| Adjusted before | yellowing | viscous | | | | |
| PRM addition | vs no pH adj. | | | | | |
| pH 4: | Much more | Very | 4 | h | 17 | h |
| Adjusted after | yellowing | viscous | | | | |
| PRM addition | vs no pH adj. | | | | | |

In general, emulsions having pH of about 7 are preferred to those having a pH of about 4, based on the properties assessed in Table 5. Furthermore, based on the results in Table 5, emulsions having pH of about 10 may be preferred to those having a pH of 7.

Additionally, based on the results in Table 5, the aldehyde-containing PRM reaches equilibrium in the emulsion more quickly than the ketone-containing PRM does.

### Example 6. Color Change Measurements

Various perfume/silicone emulsions are prepared and tested for color changes associated with each PRM. Color change is assessed according to the Color Change Measurements method provided above. Results are provided below in Table 6. It is preferred that the ΔE value of the emulsion be less than about 10, or less than about 7.5, or less than about 5, so as to have little to no impact on the color of the final product.

TABLE 6

| | | | ΔE |
|---|---|---|---|
| | PRM | | (AFTER 1 |
| # | NAME | PRM STRUCTURE | WEEK) |
| 1 | Benzalde- hyde | 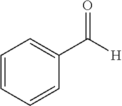 | 3.62 |
| 2 | Lilial | 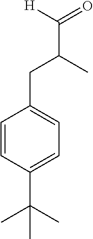 | 0.32 |
| 3 | Triplal/ Ligustral | 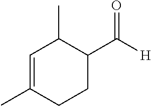 | 2.27 |
| 4 | Vernalde- hyde | 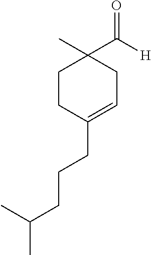 | 1.03 |
| 5 | Methyl Nonyl Acetalde- hyde | 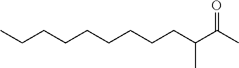 | 0.92 |
| 6 | Adoxal | 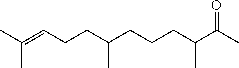 [SMILES: CC(=O)C(C)CCCC(C)CCC=C(C)C] | 0.43 |
| 7 | Floral- ozone | 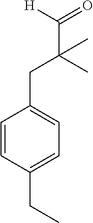 | 1.14 |
| 8 | Cinnamic Aldehyde | 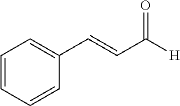 | 14.87 |
| 9 | Inter- eleven aldehyde | 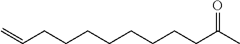 | 2.51 |
| 10 | Florhydral | 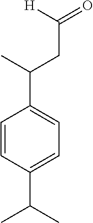 | 3.01 |
| 11 | Dupical | 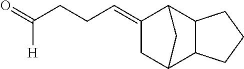 [SMILES: O=CCC/C=C1\CC2CC1C1CCCC21] | 2.57 |
| 12 | Delta- dama- scone | 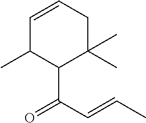 | 4.40 |

As shown in Table 6, most of the tested PRMs result in a ΔE value of less than 5 after one week of aging.

Cinnamic aldehyde, however, shows a relatively greater ΔE value, manifested as noticeable discoloration. Without wishing to be bound by theory, it is believed that the color change associated with this PRM relates to conjugation effects of the phenyl group and double bond. It may be preferred that the silicone/perfume emulsions of the present disclosure are substantially free of PRMs containing phenyl groups, double bonds, or both, so as to minimize emulsion discoloration.

### Example 7. Effect of Nitrogen Content of Silicone

To test the effect of the nitrogen content (and relative solubility) of the aminofunctional silicones on performance, fabrics are treated with three different rinse-added products: (1) where the PRMs are added neat; (2) where the PRMs are added to the product as an emulsion with an aminofunctional silicone having 3.5% nitrogen content; and (3) where the PRMs are added as an emulsion with an aminofunctional silicone having 0.7% nitrogen content. After treatment, headspace analysis data of the treated fabrics is collected for four PRMs and is reported below in Table 7.

TABLE 7

| | Fabric Headspace: nmoles/L (avg) | | | |
|---|---|---|---|---|
| | Cuminic | | | |
| Leg | aldehyde | Cymal | Adoxal | Vernaldehyde |
| PRM only | 0.07 | 0.43 | 0.45 | 0.88 |
| (comp.) | | | | |
| Silicone 1 ¹ | 2.46 | 0.36 | 0.95 | 4.60 |
| 3.5% N content | | | | |
| (comp.) | | | | |
| Silicone 2 ² | 7.00 | 2.63 | 3.73 | 7.96 |
| 0.7% N content | | | | |
| (inv.) | | | | |

¹ DMS-A11, available from Gelest, having about 3.5% nitrogen content
² KF 8003, available from Shin-Etsu, having 0.7% nitrogen content

The data in Table 7 shows that the product made from the emulsion with the silicone having a relatively low nitrogen content (e.g., less than 3.5%) provides relatively greater fabric headspace measurements, indicating relatively better freshness performance. It is believed that the higher nitrogen content correlates with increased solubility of the aminofunctional silicone, and relatively worse performance compared to aminosilicones of the present disclosure.

### Example 8. Effect of Emulsifier Selection

Aminofunctional silicones (“AFS”) having differing nitrogen contents are mixed with emulsifiers having various HLB values. The emulsions are made generally according to the procedure described above in Example 1, and results are shown in Table 8. With regard to emulsion types: OW=oil-in-water; WO=water-in-oil; WOW=water-in-oil-in-water.

TABLE 8

| | | | | Emulsifier | |
|---|---|---|---|---|---|
| | Silicone | | | EO level / | |
| | (wt % | | Emul- | silicone | |
| | nitrogen | | sifier | nitrogen | Emulsion |
| Leg | content) | Emulsifier | HLB | (wt: wt) | Type |
| 1 | AFS1¹ | a. Tergitol 15-S-3 | 8 | 400 | OW |
| | (0.1 | b. Tergitol 15-S-5 | 10.5 | 525 | OW |
| | wt % | c. Tergitol 15-S-12 | 14.5 | 725 | WOW |
| | nitrogen) | d. Tergitol 15-S-15 | 15.4 | 770 | WOW |
| 2 | AFS2² | a. Tergitol 15-S-3 | 8 | 54.5 | WO |
| | (0.7 | b. Tergitol 15-S-5 | 10.5 | 72 | WOW |
| | wt % | c. Tergitol 15-S-12 | 14.5 | 99 | OW |
| | nitrogen) | d. Tergitol 15-S-15 | 15.4 | 105.5 | OW |
| 3 | AFS3³ | a. Tergitol 15-S-3 | 8 | not | No emulsion |
| | (3.5% | | | calculated | formed |
| | nitrogen) | b. Tergitol 15-S-5 | 10.5 | not | No emulsion |
| | | | | calculated | formed |
| | | c. Tergitol 15-S-12 | 14.5 | not | No emulsion |
| | | | | calculated | formed |
| | | d. Tergitol 15-S-15 | 15.4 | not | No emulsion |
| | | | | calculated | formed |

¹AFS1 = aminosilicone ex Dow
²AFS2 = KF-8003 aminosilicone, ex Shin Etsu
³AFS3 = DMSA11 aminosilicone, ex Gelest (an aminopropyl terminated polydimethyl siloxane)

It has been found that those selections resulting in oil-in-water (“OW”) emulsion types are preferred, as they are most easily incorporated into certain consumer products, such as aqueous liquid fabric softeners.

As shown by the results in Table 8, aminofunctional silicones having different amine contents require different emulsifiers (characterized by different HLB values) to form an effective oil-in-water (OW) emulsion type. In general, the lower the nitrogen content of the aminofunctional silicone (and therefore, the less water-soluble the aminofunctional silicone), the lower the HLB of the emulsifier should be. Depending on the aminofunctional silicone selected, the emulsifier may be characterized by an HLB value of less than 11, or greater than 11.

As shown by the results in Table 8, preferred weight ratios of the emulsifier ethoxylate (EO) level to the nitrogen content of the silicone may be from about 75 to about 700, or from about 99 to about 525.

As indicated in Table 8, the aminosilicone of Leg 3 is not able to be effectively emulsified using the selected emulsifiers. It is believed that the aminofunctional silicone's high nitrogen content (about 3.5 wt %) contributes to a high solubility in water, making it challenging to create an emulsion in water.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A perfume/silicone emulsion composition (“emulsion composition”) comprising:
an aminofunctional silicone,
wherein the aminofunctional silicone comprises one or more primary amine moieties, and
wherein the aminofunctional silicone is characterized by a total amine content of from about 0.05 to about 2.2;
one or more emulsifiers;
one or more perfume raw materials,
wherein the one or more perfume raw materials comprises an aldehyde moiety, a ketone moiety, or combinations thereof; and
water.

2. The perfume/silicone emulsion composition of claim 1, wherein the emulsion composition is characterized by a pH of 7.0 or greater, wherein pH is measured as a 10% dilution of emulsion in deionized water (i.e., 10 parts by weight of emulsion, 90 parts by weight of deionized water).

3. The perfume/silicone emulsion composition of claim 1, wherein the aminofunctional silicone is characterized by a total amine content of from about 0.071 to about 2.14.

4. The perfume/silicone emulsion composition of claim 1, wherein the aminofunctional silicone is characterized by a primary amine content of from about 0.05 to about 2.2.

5. The perfume/silicone emulsion composition of claim 1, wherein the aminofunctional silicone is characterized by a ratio of primary amine content to total amine content of from about 1:2 to about 1:1.

6. The perfume/silicone emulsion composition of claim 1, wherein the emulsifier comprises a first emulsifier and a second emulsifier that is different from the first emulsifier,
optionally wherein the first emulsifier is a linear nonionic surfactant, and/or
optionally wherein the second emulsifier is a branched nonionic surfactant.

7. The perfume/silicone emulsion composition of claim 1, wherein the one or more perfume raw materials is characterized by the following structure: 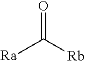
wherein Ra is selected from the group consisting of: C₃-C₁₈ alkyl, C₃-C₁₈ alkenyl, C₃-C₁₈ substituted alkyl, 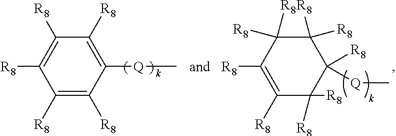
wherein each R₈ is independently selected from the group consisting of H, straight or branched chain C₁-C₈ alkyl, C₁-C₈ substituted alkyl, and C₁-C₂ alkoxy,
k is an integer with value 0 or 1, and
Q is an alkylene radical with from 2 to 8 carbon atoms; and
wherein Rb is selected from H and —CH═CH—R₉,
wherein R₉ is selected from H or a C₁-C₃ alkyl group.

8. The perfume/silicone emulsion composition of claim 7, wherein Ra is selected from the group consisting of:

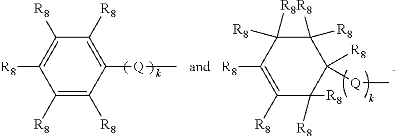

9. The perfume/silicone emulsion composition of claim 7, wherein at least two R₈ groups are fused to form a bicyclic structures.

10. The perfume/silicone emulsion composition according to any of claim 7, wherein each Q is independently selected from 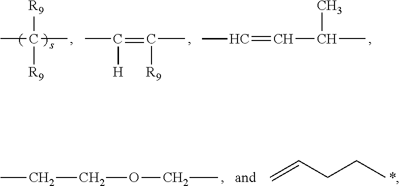
wherein s is an integer from 1 to 4, and
wherein each R₉ is independently selected from H or C₁-C₃ alkyl group, and
where * represents the end of the moiety linked to the Ra group,
preferably wherein each Q is independently selected from

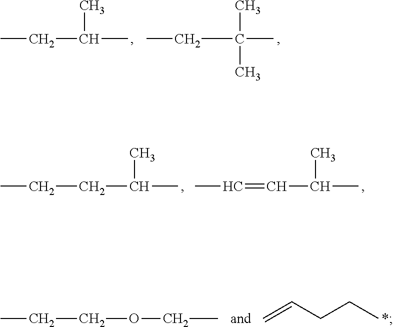

11. The perfume/silicone emulsion composition of claim 7, wherein Rb is H.

12. The perfume/silicone emulsion composition of claim 1, wherein the one or more perfume raw materials is characterized by the following structure: 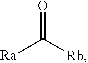
and wherein Ra and Rb are selected from one of the following combinations:
a. Ra is selected from the group consisting of: C₃-C₁₈ alkyl, C₃-C₁₈ alkenyl, and C₃-C₁₈ substituted alkyl; and
b. Ra is selected from 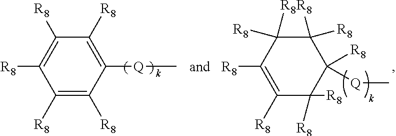
wherein k is 0, and
wherein R₈ is selected from the group consisting of H, C₁-C₃ alkyl, and C₁-C₂ alkoxy; and
Rb is 0;
c. Ra is selected from the group consisting of: 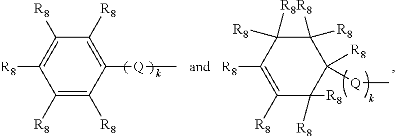
k is 1,
R₈ is selected from the group consisting of H, C₁-C₃ alkyl, and C₁-C₂ alkoxy, and
Q is selected from the group consisting of: 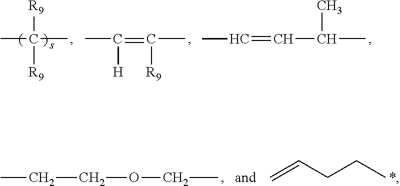
preferably Q is selected from 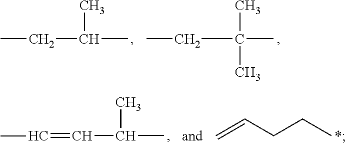
and
Rb is H;
d. Ra is selected from the group consisting of: 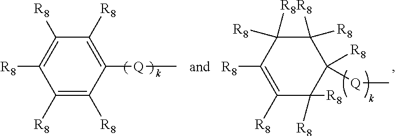
wherein k is 0, and
Rb is —CH═CH—R₉.

13. The perfume/silicone emulsion composition of claim 1, wherein the one or more perfume raw materials comprise a material selected from the following:
a. oncidal, methyl nonyl acetaldehyde, adoxal, melanal, calypsone, or mixtures thereof;
b. cuminic aldehyde, benzaldehyde, anisic aldehyde, heliotropin, isocyclocitral, triplal/ligustral, 3,6-ivy carbaldehyde, ligustral, scentenal, or mixtures thereof;
c. satinaldehyde (jasmorange), otropal, cyclamen homoaldehyde, cyclamen aldehyde (cyclamal), lilial, canthoxal, floralozone, cinnemic aldehyde, or mixtures thereof;
d. delta-damascone, beta-damascone, alpha-damascone, nectaryl, or mixtures thereof;
e. vanillin, ethyl vanillin, or mixtures thereof; or
f. a combination of materials selected from at least two categories of a, b, c, d, and e.

14. The perfume/silicone emulsion composition of claim 1, wherein the aminofunctional silicone is characterized by the following formula:
[R₁R₂R₃SiO_{1/2}]₍ⱼ₊₂ₗ₊₂₎[R₄R₅SiO_{2/2}]ₘ[R₆SiO_{3/2}]ⱼ[SiO_{4/2}]ₗ
wherein
j is an integer from 0 to 150;
m is an integer from 10 to 1500;
l is an integer from 0 to 150;
with the provisio j+m+l equals an integer greater than or equal to 50;
each of R₁, R₂, R₃, R₄, R₅ and R₆ moieties is independently selected from the group consisting of H, OH, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl, C₁-C₃₂ alkoxy and C₁-C₃₂ substituted alkoxy, and X—Z, wherein at least one of the moieties R₁ through R₆=X—Z;
wherein each X is independently a substituted or unsubstituted divalent alkylene or alkylidene radical comprising 2-12 carbon atoms;
wherein each Z is a moiety comprising the one or more primary amine moieties.

15. The perfume/silicone emulsion composition of claim 1, wherein the emulsion comprises from about 10% to about 70%, or from about 25% to about 65%, or from about 50% to about 65%, by weight of the silicone emulsion, of the aminofunctional silicone.

16. The perfume/silicone emulsion composition of claim 1, wherein the emulsion comprises from about 30% to about 90%, or from about 35% to about 75%, or from about 35% to about 50%, by weight of the emulsion, of water.

17. A method of making the perfume/silicone emulsion composition of claim 1, the method comprising the steps of mixing the aminofunctional silicone, the one or more emulsifiers, and the one or more perfume raw materials in the presence of the water.

18. A consumer product composition comprising:
the perfume/silicone emulsion composition according to claim 1; and
a consumer product adjunct.

19. The consumer product composition according to claim 18, wherein the consumer product adjunct is selected from an amine, a surfactant system, a water-binding agent, a sulfite, fatty acids and/or salts thereof, enzymes, encapsulated benefit agents, soil release polymers, hueing agents, builders, chelating agents, dye transfer inhibiting agents, dispersants, enzyme stabilizers, catalytic materials, bleaching agents, bleach catalysts, bleach activators, polymeric dispersing agents, soil removal/anti-redeposition agents, polymeric dispersing agents, polymeric grease cleaning agents, brighteners, suds suppressors, dyes, hueing agents, free perfume, structure elasticizing agents, fabric softening agents, carriers, fillers, hydrotropes, organic solvents, anti-microbial agents and/or preservatives, neutralizers and/or pH adjusting agents, processing aids, fillers, rheology modifiers or structurants, opacifiers, pearlescent agents, pigments, anti-corrosion and/or anti-tarnishing agents, and mixtures thereof.

20. The consumer product composition according to claim 18, wherein the consumer product adjunct comprises free perfume, preferable free perfume that comprises perfume raw materials that do not comprise an aldehyde moiety.
